(19) United States
(12) Patent Application Publication
(10) Pub. No.: US 2013/0060597 A1
(43) Pub. Date: Mar. 7, 2013

(54) KNOWLEDGE AND PROCESS BASED ESTIMATION SYSTEM FOR ENGINEERING PRODUCT DESIGN

(71) Applicants: Dharmalingam Thangavelu, Tirupur (IN); Mandyam Anandanpillai Parthasarathy, Bangalore (IN); Srividhya Velarcaud Srinivasan, Chennai (IN)

(72) Inventors: Dharmalingam Thangavelu, Tirupur (IN); Mandyam Anandanpillai Parthasarathy, Bangalore (IN); Srividhya Velarcaud Srinivasan, Chennai (IN)

(73) Assignee: Infosys Limited, Bangalore (IN)

(21) Appl. No.: 13/330,344

(22) Filed: Dec. 19, 2011

(30) Foreign Application Priority Data
Sep. 5, 2011 (IN) 3046/CHE/2011

(51) Int. Cl. G06Q 10/06; G06F 7/60

(52) U.S. Cl. 705/7.27; 703/2

(57) ABSTRACT

According to the one aspect of the present disclosure, a method for knowledge and process based estimation model for product development activities of engineering services comprises: accepting a plurality of input details of a product. A component of the product is chosen for the purpose of estimation. The method of the present embodiment also comprises choosing the complexity of the component. A stream for estimation is selected and a process depending on the stream is also selected. Furthermore, the method comprises, choosing the complexity of the process to estimate. Based on all the selected parameters, the pre-defined data is estimated. A report can also be generated based on the estimated data. The method further defines the process of mapping effort estimates for engineering activities in a product development lifecycle phases to a unique work sizing metric called Engineering Functions Units of Work (EFUoW).

### FIELD

The present disclosure relates to estimation module for product development activities of engineering services, and particularly, to a system and a method for knowledge and process based estimation model for product development activities of engineering services.

### BACKGROUND

Inconsistent estimation, dependency on experienced experts (In engineering acquiring expertise needs decades of experience), and non-standard estimations are the main limitations. Dependency on the expertise/expert is major constraint for OEM's to scale up. There is no standard baseline estimation is available to bench mark the various engineering service providers. This is a huge constraint for the OEM's while outsourcing the product development activities of engineering services. There are currently no established or prescribed standards for estimating engineering services have been published. There are very limited or no scientific/knowledge based estimation model available in the industry at present to estimate product development activities of engineering services. Currently estimation for product development activities of engineering services is being done based on the expert judgment and experience of domain experts. Hence it is inconsistent, person dependent, and not repeatable.

A wide range of engineering activities across the lifecycle stages of a given product, from evolution to retirement, can be grouped into smaller, definable and executable services. With the advent of outsourcing in the core product and process engineering industry, these services are commonly known as “Engineering Services.” For example an engineering analyses process, a design process or a manufacturing process are a few varieties of engineering services. Typically each engineering service will consist of a set of pre-defined activities, the outcome of which is also predictable with a fair level of accuracy.

### SUMMARY

Aspects of the disclosure relate to a method and a system for knowledge and process based estimation model for product development activities of engineering services.

According to the one aspect of the present disclosure, a method for knowledge and process based estimation model for product development activities of engineering services comprises: accepting a plurality of input details of a product. A component of the product is chosen for the purpose of estimation. The method of the present embodiment also comprises choosing the complexity of the component. A stream for estimation is selected and a process depending on the stream is also selected. Furthermore, the method comprises, choosing the complexity of the process to estimate. Based on all the selected parameters, the pre-defined data is estimated. A report can also be generated based on the estimated data.

According to another aspect of the present disclosure, the method also comprises enabling the user to alter the project execution factor.

According to another aspect of the present disclosure, the user can be provided with an option of experience based estimation. The user may also increase or decrease a value in the effort parameter. The activity headers may also be altered, wherein the alteration may also include removing an activity from the activity header.

### DRAWINGS

These and other features, aspects, and advantages of the present invention will be better understood when the following detailed description is read with reference to the accompanying drawings in which like characters represent like parts throughout the drawings, wherein:

FIG. 1a is a flow chart illustrating a method 100 for knowledge and process based estimation model for product development activities of engineering services, in accordance with an embodiment of the present disclosure;

FIG. 1b is a continuation flow chart of the method for knowledge and process based estimation model for product development activities of engineering services, in accordance with an embodiment of the present disclosure;

FIG. 2 is an example embodiment describing accepting general information from the user, in accordance with an embodiment of the present disclosure;

FIG. 3 is an example embodiment of the present disclosure describing product and component selection for estimation;

FIG. 4 is an example embodiment of the present disclosure, which describes selecting the complexity of the component and the component stream;

FIG. 5 is an example embodiment of the present disclosure which describes extracting the resultant component factor;

FIG. 6 is an example embodiment of the present disclosure which describes selecting the process and the process complexity;

FIG. 7 is an example embodiment of the present disclosure which describes extracting the activity steps and the estimated effort;

FIG. 8 is an example embodiment of the present disclosure which describes identifying the project execution factor;

FIG. 9 is another embodiment of the present disclosure which describes altering the activity chart;

FIG. 10 is another embodiment of the present disclosure which describes the overhead activities;

FIG. 11 is a system illustrating a generalized computer network arrangement, in accordance with an embodiment of the present invention;

FIG. 12 is an illustrative example of the present disclosure;

FIG. 13 is a graphical view of the various levels of processes and activity breakdown;

FIG. 14 is an illustrative explanation of knowledge based estimation service; and

FIG. 15 is explanation of structure of engineering work units show a possible way to componentize engineering services.

### DETAILED DESCRIPTION

The present disclosure proposes a method for knowledge and process based estimation model for product development activities of engineering services.

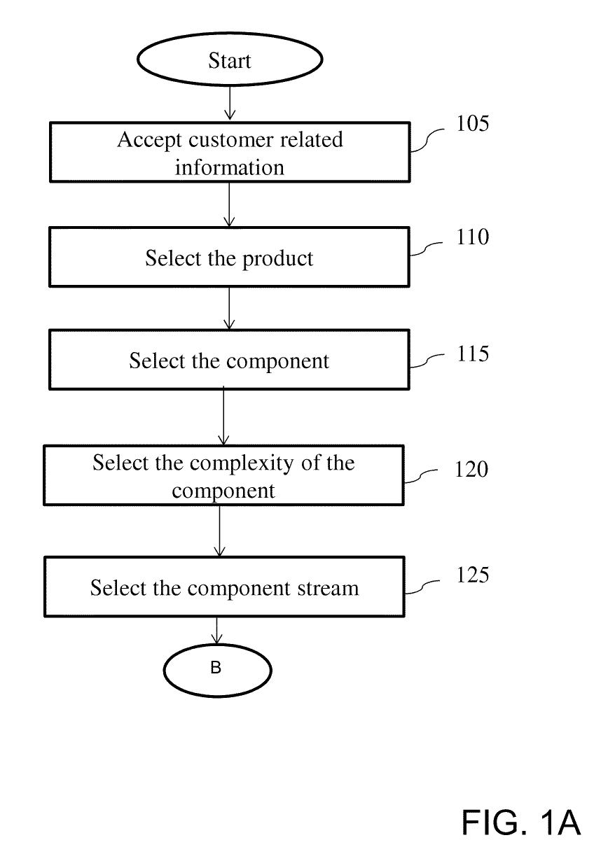

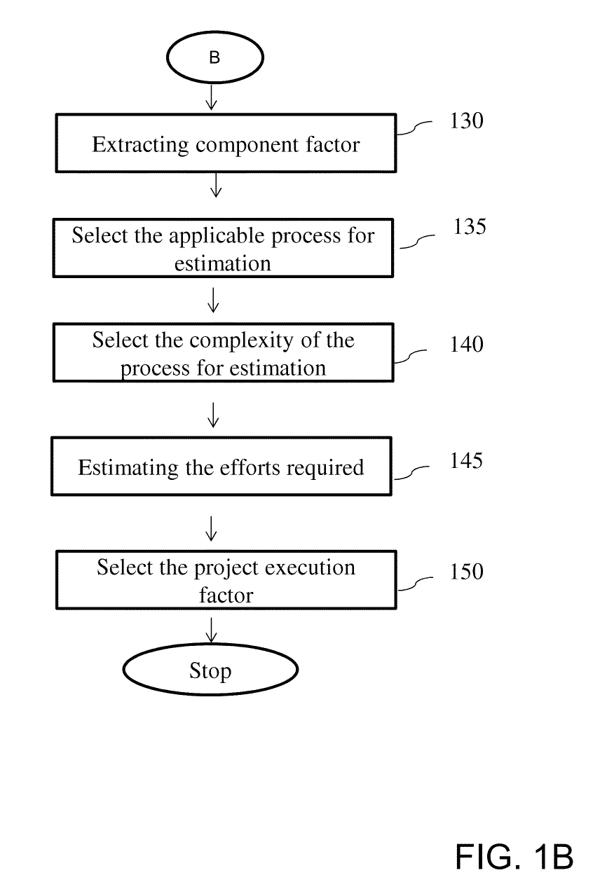

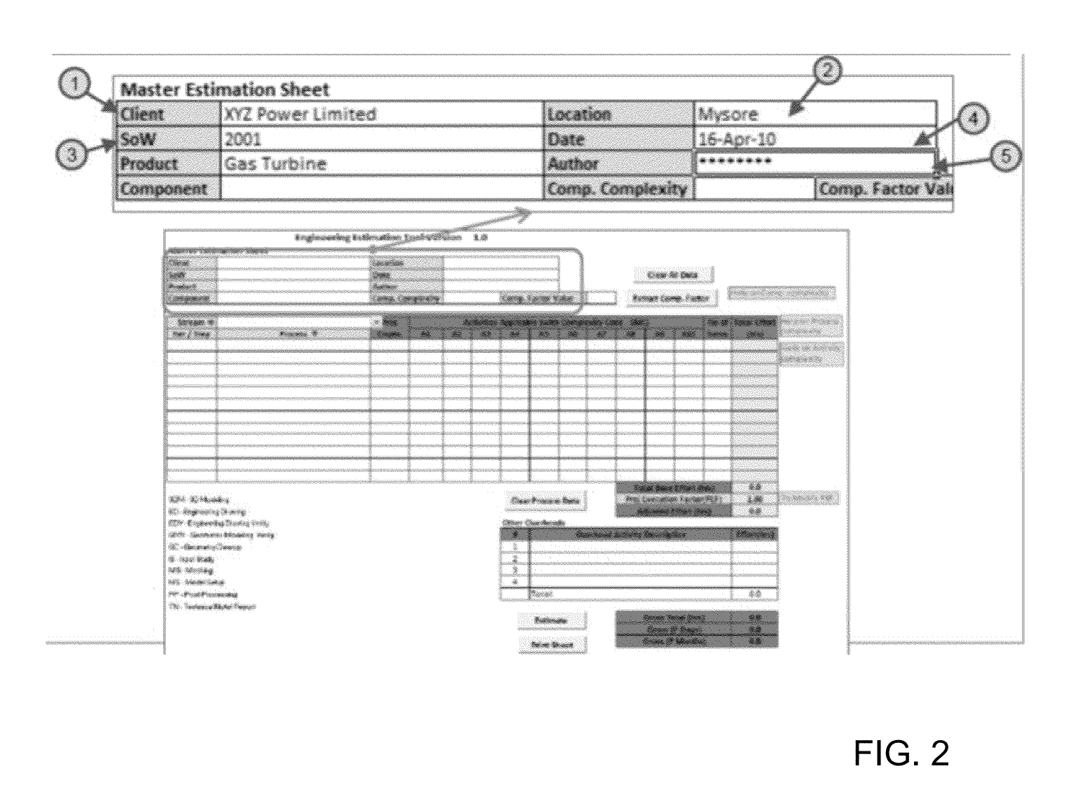

FIG. 1a is a flow chart illustrating a method for knowledge and process based estimation model for product development activities of engineering services, in accordance with an embodiment of the present invention. The step 105 of the method involves accepting customer related information. The step 105 can be further explained with reference to FIGS. 2. 1 to 5 of FIG. 2 requires certain general information to be entered about the product or process being estimated. The Master Estimation Sheet header provides space for 1: To fill client's name; 2: To fill client's location; 3: To provide information about the statement of work (contract); 4: To Provide date of contract (Statement of Work) and 5: To provide name of author (using the tool to estimate).

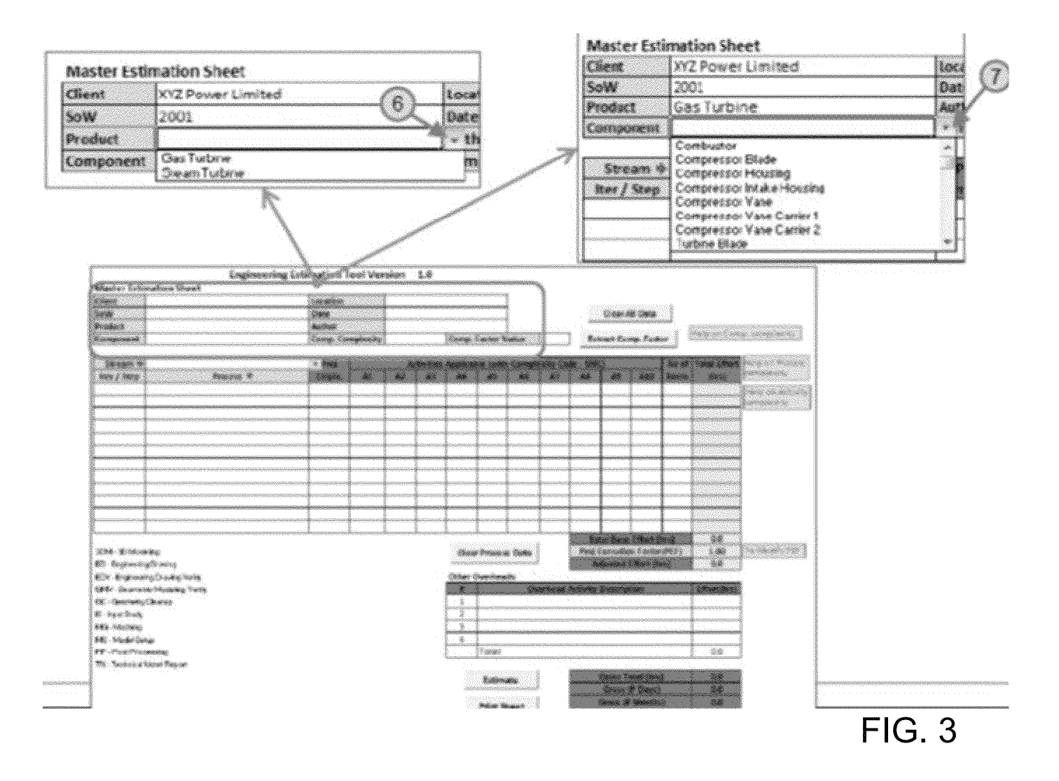

FIG. 3 is an example embodiment of the present disclosure describing product and component selection for estimation. FIG. 3 is a further explanation of step 110 of FIG. 1a. Reference number 6 explains: From the pre-defined drop-down list of product options available choose the product for which the estimation is being done ex. Gas Turbine or Steam Turbine. The reference number 7 explains with reference to step 115 of FIG. 1a: From the pre-defined drop-down list of component options available choose the component for which the estimation is being done ex. Bearing Pedestal, Compressor Blade, Compressor Vane etc.

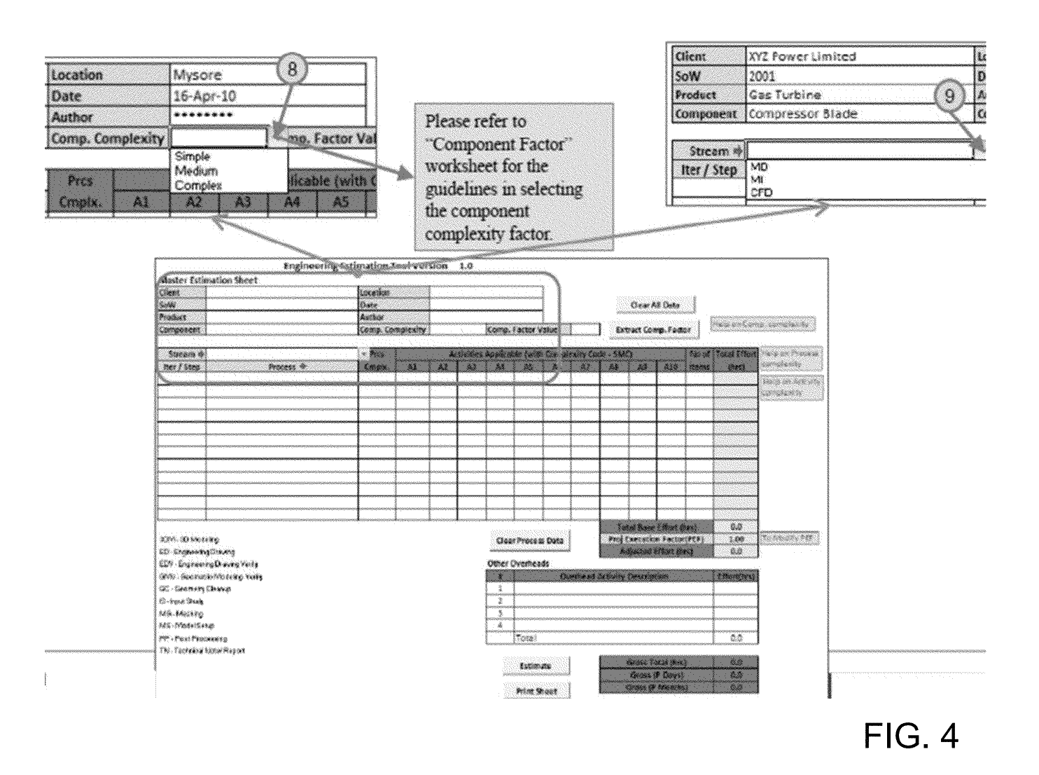

FIG. 4 is an example embodiment of the present disclosure, which describes selecting the complexity of the component and the component stream. FIG. 4 is a further explanation of step 120 of FIG. 1a. The reference number 8 of FIG. 4 explains: from the pre-defined drop-down list of component complexity factor options available choose the component complexity factor applicable for the estimation that is being done. The component factor value that depends on the size, complexity and severity of the various components are stored in the estimation tool and are broadly classified into simple, medium and complex categories. Furthermore, reference number 9 explains with reference to step 125 of FIG. 1a: from the pre-defined drop-down list of component stream options available choose the component stream for which the estimation is being done ex. Mechanical Design & Drafting Process (MD), Mechanical Integrity Process (MI) and Computational Fluid Dynamics Process (CFD).

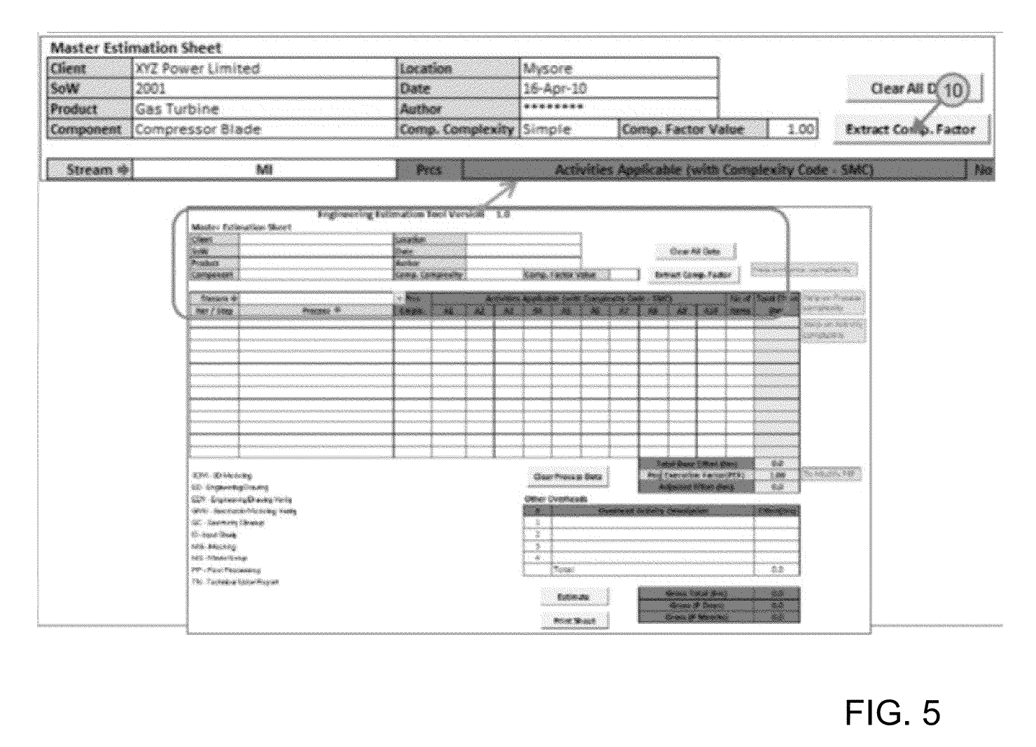

FIG. 5 is an example embodiment of the present disclosure which describes extracting the resultant component factor. FIG. 5 is a further explanation of step 130 of FIG. 1b. Having filled information regarding the component and component complexity, the resultant component factor value has to be extracted from a pre-defined list. This is done by just clicking on the button “Extract Comp. Factor”. The extracted data will automatically appear in the Com. Factor Value data box.

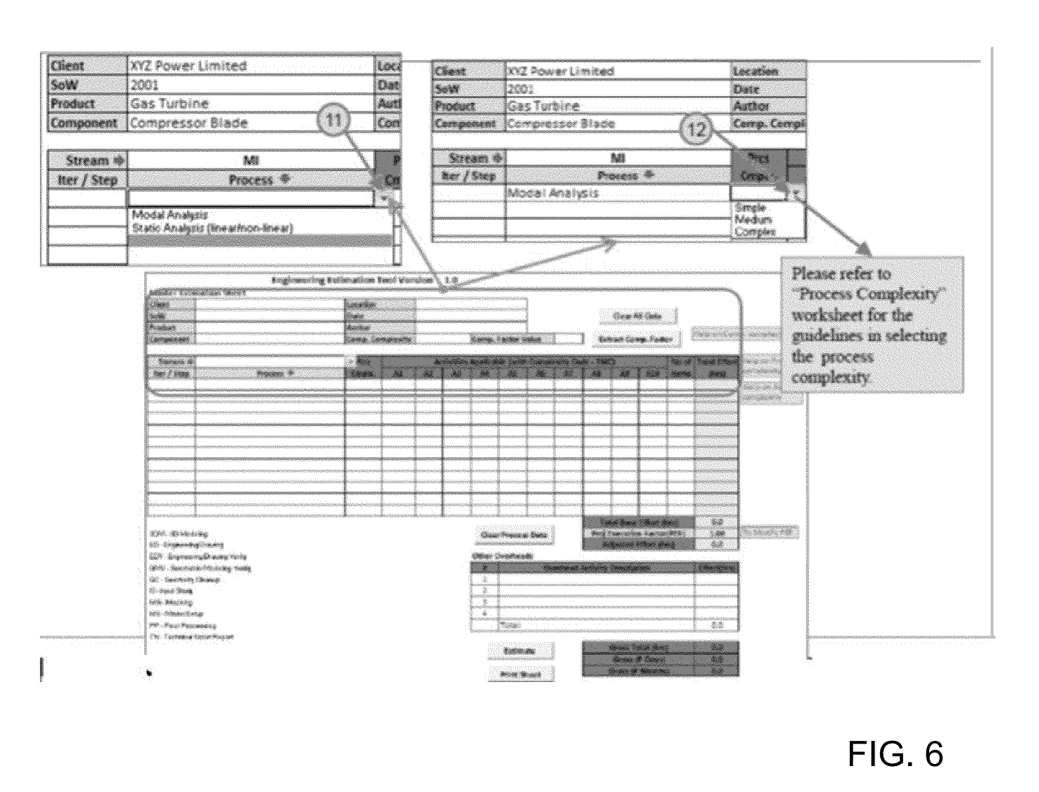

FIG. 6 is an example embodiment of the present disclosure which describes selecting the process and the process complexity. FIG. 6 is a further explanation of step 135 and 140 of FIG. 1b. Reference number 11 & 12 are provided to provide details of each and every process that is applicable for the estimation process purposes. The user will need to choose one process at a time and the corresponding complexity of the process. The tool will automatically fill other relevant information. Reference number 11 explains with respect to step 135 of FIG. 1b: from the pre-defined drop-down list of process options available choose the process applicable for the estimation that is being done. Reference number 12 explains with respect to step 140 of FIG. 1b: From the pre-defined drop-down list of process complexity options available choose the appropriate complexity for which the estimation is being done. The process complexities can be broadly classified but not limited to simple, medium and complex categories.

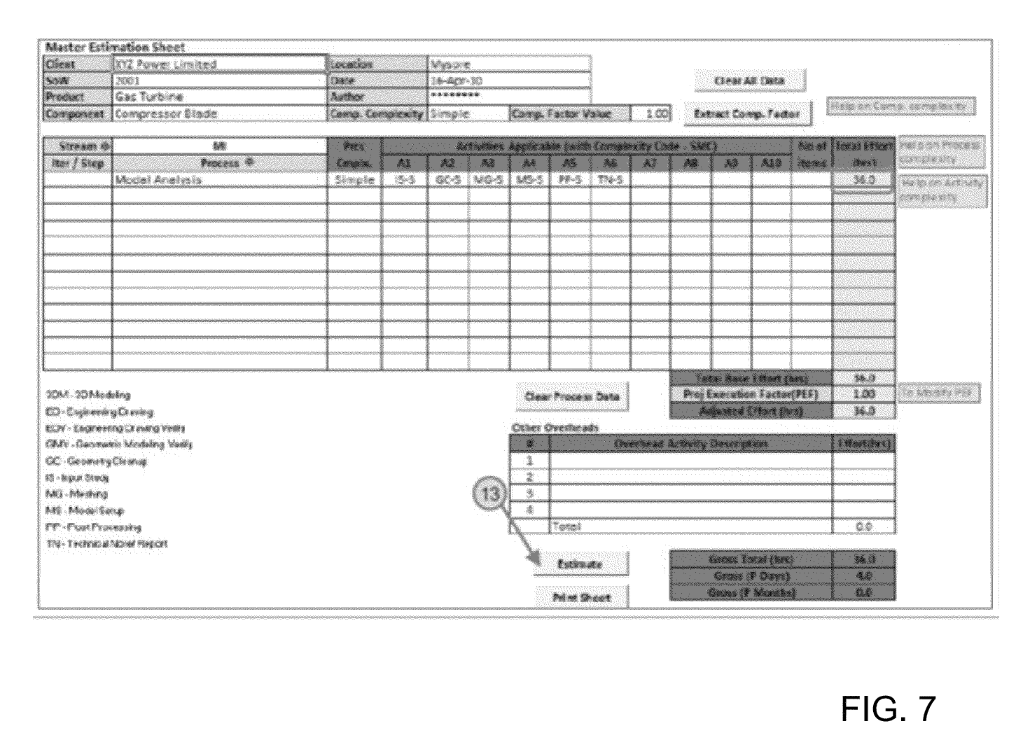

FIG. 7 is an example embodiment of the present disclosure which describes extracting the activity steps and the estimated effort. FIG. 7 is a further explanation of step 145 of FIG. 1b. Once the user has filled all the processes and its respective complexity values, the respective activity steps and he estimated effort etc., can be extracted by clicking on the “Estimate” button.

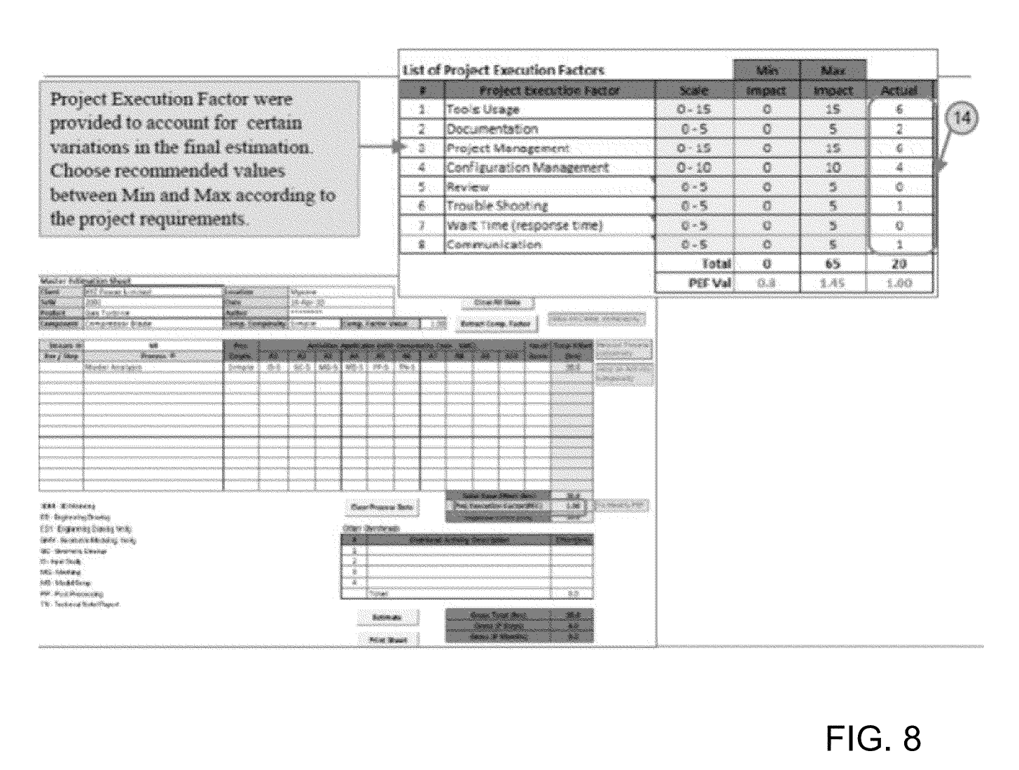

FIG. 8 is an example embodiment of the present disclosure which describes identifying the project execution factor. FIG. 8 is a further explanation of step 150 of FIG. 1b. This step requires the user to identify the “project execution factor” (PEF). The PEF is typically dependent on several project environment factors that help define the additional complexities involved that help derive additional estimated effort. The user will have to click on the sheet “Project Execution Factor” and provide figures in the “Actual” column for each of the parameters as shown on the top right side of the figure above. Based on the “Actual” figures, the tool will automatically calculate the PEF factor and update it on the master sheet as shown above.

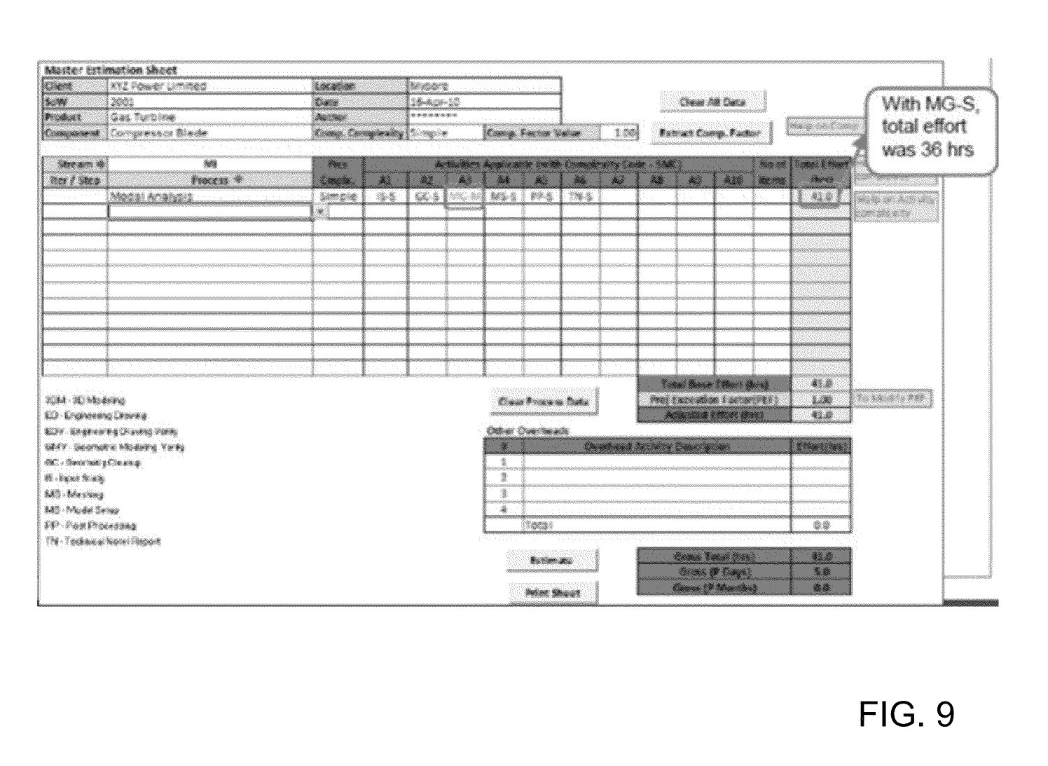

FIG. 9 is another embodiment of the present disclosure which describes altering the activity chart. This tool has an additional feature that even after the user has identified a process and its complexity, he has the option of further re-calibrating the results manually. The user can locally add or delete an activity or change the complexity of a specific activity as desired (see activity A3 above). The resultant estimated effort will also change automatically as shown for MG-S above. If there is any change to the activity complexity than suggested, it is highlighted in red color. This would enable the reviewer to identify the deviation taken against the knowledge based estimation.

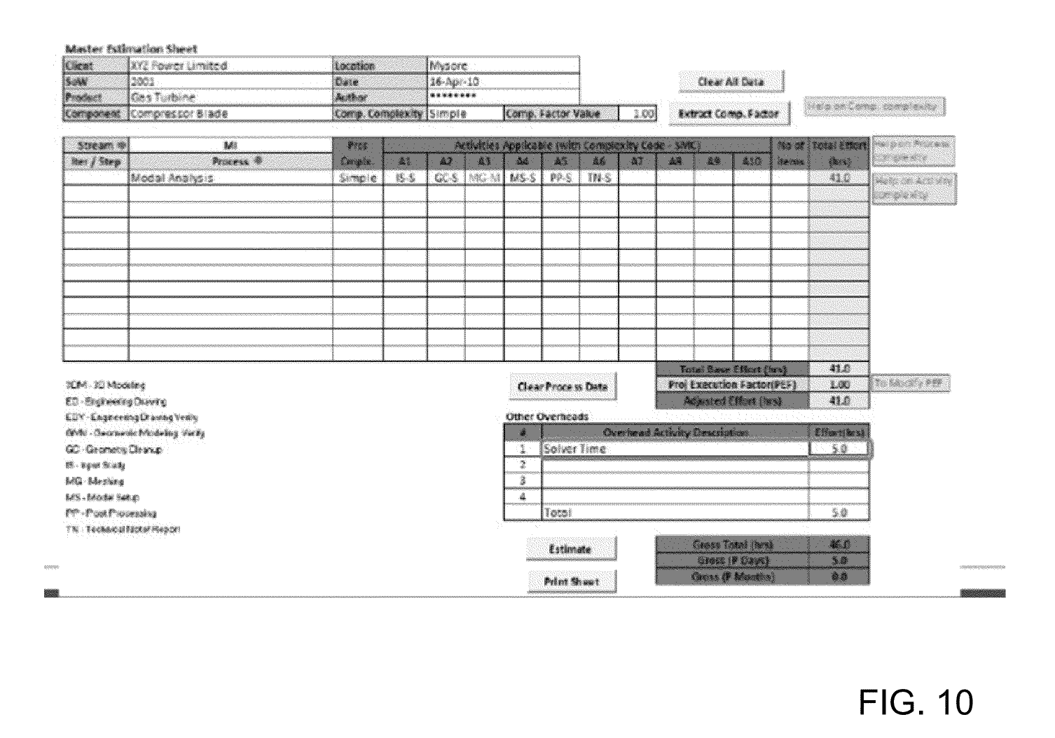

FIG. 10 is another embodiment of the present disclosure which describes the overhead activities. While estimating efforts for processes, sometimes it is felt by the user that there could be a few very special activities that are not normally executed but may be required in a one-off case. The tool has been provided with such a capability wherein the user can add other overhead activities that could compensate for such additional efforts. One such overhead activity called “solver time” has been shown in the picture above.

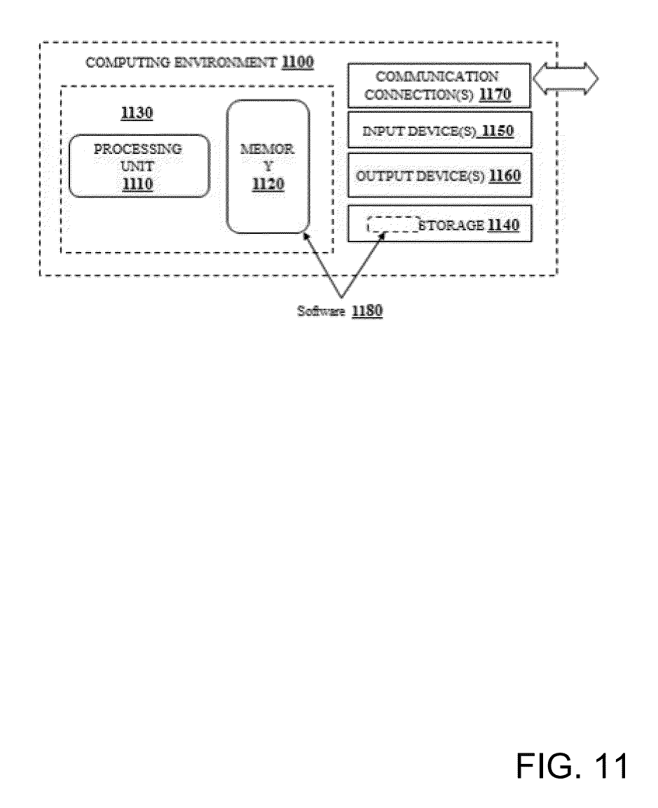

One or more of the above-described techniques may be implemented in or involve one or more computer systems. FIG. 11 illustrates a generalized example of a computing environment 1100. The computing environment 1100 is not intended to suggest any limitation as to scope of use or functionality of described embodiments.

With reference to FIG. 11, the computing environment 1100 includes at least one processing unit 1110 and memory 1120. In FIG. 11, this most basic configuration 1130 is included within a dashed line. The processing unit 1110 executes computer-executable instructions and may be a real or a virtual processor. In a multi-processing system, multiple processing units execute computer-executable instructions to increase processing power. The memory 1120 may be volatile memory (e.g., registers, cache, RAM), non-volatile memory (e.g., ROM, EEPROM, flash memory, etc.), or some combination of the two. In some embodiments, the memory 1120 stores software 1180 implementing described techniques.

A computing environment may have additional features. For example, the computing environment 1100 includes storage 1140, one or more input devices 1150, one or more output devices 1160, and one or more communication connections 1170. An interconnection mechanism (not shown) such as a bus, controller, or network interconnects the components of the computing environment 1100. Typically, operating system software (not shown) provides an operating environment for other software executing in the computing environment 1100, and coordinates activities of the components of the computing environment 1100.

The storage 1140 may be removable or non-removable, and includes magnetic disks, magnetic tapes or cassettes, CD-ROMs, CD-RWs, DVDs, or any other medium which may be used to store information and which may be accessed within the computing environment 1100. In some embodiments, the storage 1140 stores instructions for the software 1180.

The input device(s) 1150 may be a touch input device such as a keyboard, mouse, pen, trackball, touch screen, or game controller, a voice input device, a scanning device, a digital camera, or another device that provides input to the computing environment 1100. The output device(s) 1160 may be a display, a television, a hand held device, a head mounted display or a Kiosk that provides output from the computing environment 1100.

The communication connection(s) 1170 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 1100, computer-readable media include memory 1120, storage 1140, communication media, and combinations of any of the above.

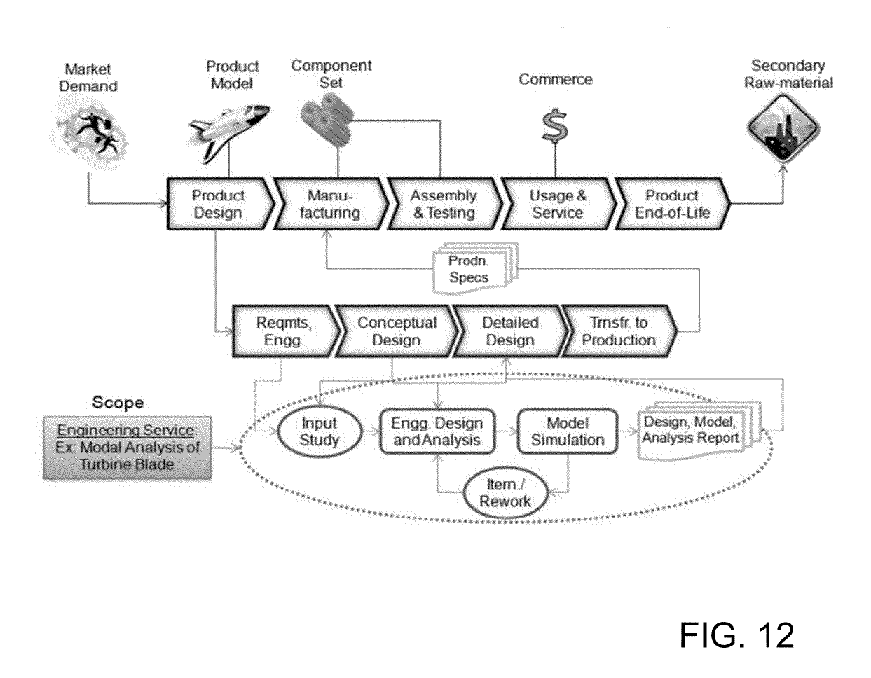

FIG. 12 is an illustrative example of the present disclosure. Broadly the very high level break-down of processes in the product lifecycle can be classified into: Product Design, Manufacturing, Assembly and Testing, Usage and Service and Product End-of-Life. By taking the lifecycle phases onto the next level, considering the set of major activities that could typically happen between the product design and the manufacturing phase, they could be classified into, requirements engineering, conceptual design, detailed design and transfer to production. These activities can be further broken into smaller activities keeping in view the analyses and design processes that are typically executed in a product design phase. When applied to the Gas Turbine as a product, the engineering analysis activities that occur between the requirements engineering, conceptual design and detailed design could be broken down into, input study, engineering design and analysis, model simulation, design, model analysis report. Also, the set of activities identified above are together termed as “Modal Analysis”, “General Computational Fluid Dynamics Analysis”, and “Detailing with References” etc. And these activities if performed by a group of engineers are called an engineering service. By following a similar process of identifying engineering services, one could put together a fairly large number of services that could broadly encompass the overall lifecycle stage of a product development engineering process.

FIG. 12 illustrates the high level lifecycle stages of a typical product development process that are followed in almost all major design and manufacturing industries. For the purpose of enumerating a typical sample explosion of a sub-process within a lifecycle stage the details of the sub-processes involved between the process design and manufacturing stages have been depicted. Further drilling down of sub-processes into sub-sub-processes has been explained with specific reference to activities from requirements specifications till detailed design stages. The purpose of this figure is to explain the process of exploding a given product development lifecycle stage into multiple levels till the lowest level finally maps to a set of definable engineering activities.

A framework should typically consist of the different components of the system that could be suitably assembled to arrive at the final product. The components, and sub-components if required, should be identified to a level of granularity such that developing variants of the end product could be facilitated continually. Additionally the overall framework should encompass all such features with enough flexibility built in for the current as well as future needs with minimal tailoring. In order to identify the components, sub-components and the smallest level activities for a typical engineering service, we took the “Modal Analysis Process” for a typical Gas Turbine as our case study. Detailed inputs were obtained from subject matter experts involved in routine “Modal Analysis Process” activities. Data were collated for fairly large number of incidences of analyses, patterns were observed and after excluding exceptions the final set of typical activities for a particular analysis process emerged. It was also observed that the engineering analyses, though similar from process angle, took different efforts to execute due to unique nature of the work. Basically a “process explosion” act was executed on a typical engineering analysis activity as a service as applied to a Gas Turbine component. The assumptions were as follows; Effort needs to be measured independent of the estimator or the person executing the activity. A Gas Turbine component (or a sub-assembly of components) could be systematically broken down into a number of engineering analyses, and each of the analyses could be classified into Simple, Medium and Complex. Moving down to the next level, an engineering analysis process could be further broken down into a set of activities, and each activity itself could be of complexity Simple, Medium and Complex.

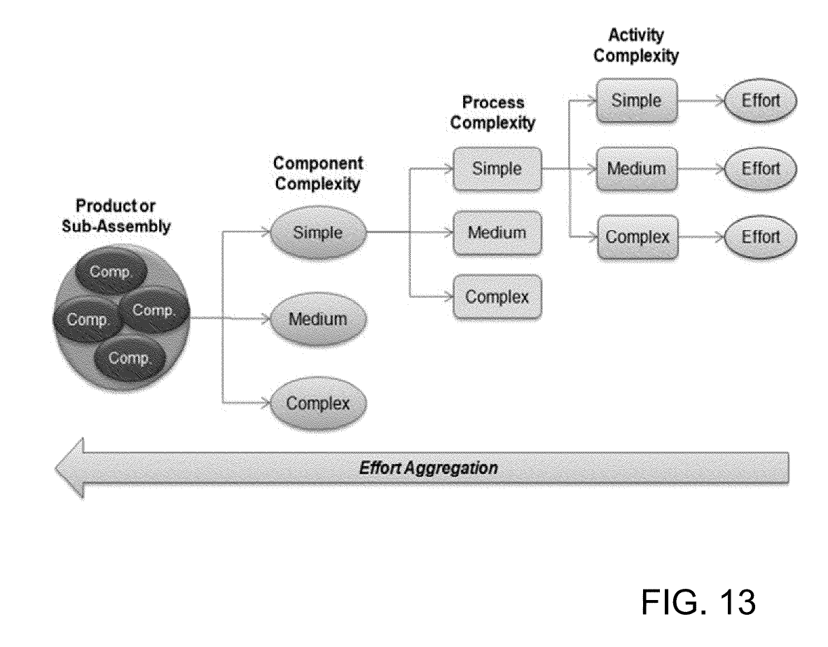

FIG. 13 gives a graphical view of the various levels of processes and activity breakdown. It is evident that through the process explosion method one could work upward (right to left) and aggregate the total effort for any activity, design process for a component or even an assembly of components. FIG. 13 describes the process of classifying complexity factors at component or sub-assembly level, analysis and design process level as well as finally at the engineering activity levels itself. Broadly the complexity factors are divided into three major varieties namely simple, medium and complex. Further based on the complexity of the engineering activity a suitable effort is assigned also based on past experience.

It is essential that an estimation framework should encompass all possible permutations and combinations that could occur in the process of estimating the effort for a particular engineering service. As such, the large number of data points that were collated based on similar projects executed in the past were dissected and analyzed for identification of repeatable patterns. The intent was to build a relationship model between individual activities, their complexity, variety of processes which were applied to a variety of components and sub-assemblies.

For the purpose of building the first draft estimation framework design, the two main engineering products chosen were Gas Turbine and Steam Turbine. Next, there were three main design analysis process (engineering services) were identified that were commonly used across the two variety of Turbines. These analysis processes were: Mechanical Integrity Process (MI), Mechanical Design & Drafting Process (MD), and Computational Fluid Dynamics Process (CFD). Further, a set of definable and repeatable activities were identified for each of the above processes MI, MD and CFD. A careful verification of individual activities showed that there were more than one activity that were common across the analysis processes MI, MD & CFD.

Another illustrative example of the present disclosure describes a relationship between activities & processes. Using a bottom-up approach, the aggregation of a set of activities into an design analysis process which further adds up to the overall effort for a component was established. The flexibility has been built in within the framework design such that any set of activities, from the total number of activities available, could together define an engineering service. While designing the estimation framework, it was essential to provide for certain variations in the final estimated figure due to certain project execution factors. These factors typically vary based on a few definable parameters that are specific in a given project. Here are a few examples: Usage of Tools, Extent of Documentation (effort), Configuration Management, Project Management and Others. The project execution factors were observed to have an overall effect on the total execution effort based on activities, processes, component and its complexity.

Traditionally, an estimation framework design facilitates calculation of the total effort of a given project. Which means the estimated effort includes all the lifecycle stages of the project execution. The above estimation framework design calculates the total effort for a given engineering service, from start to finish. Whereas a framework based estimation model can generate estimates that are predictable within a certain range, it is the repeated use and fine tuning the activity level efforts that helps in reducing the variation between estimated and actual effort.

Any product is as good as its value perceived by the end users. And very similar to any other deployment related issues faced while implementing a new, process based initiative, a completely new concept of an estimation framework for engineering services too is tough, complex and quite a challenge in many respects. Historically there are hardly any estimation processes for engineering services that have been published, accepted and implemented in a large scale services oriented organization. As such it is obvious that introducing a new concept such as this estimation framework will be treated with good amount of skepticism and lack of confidence in the end result.

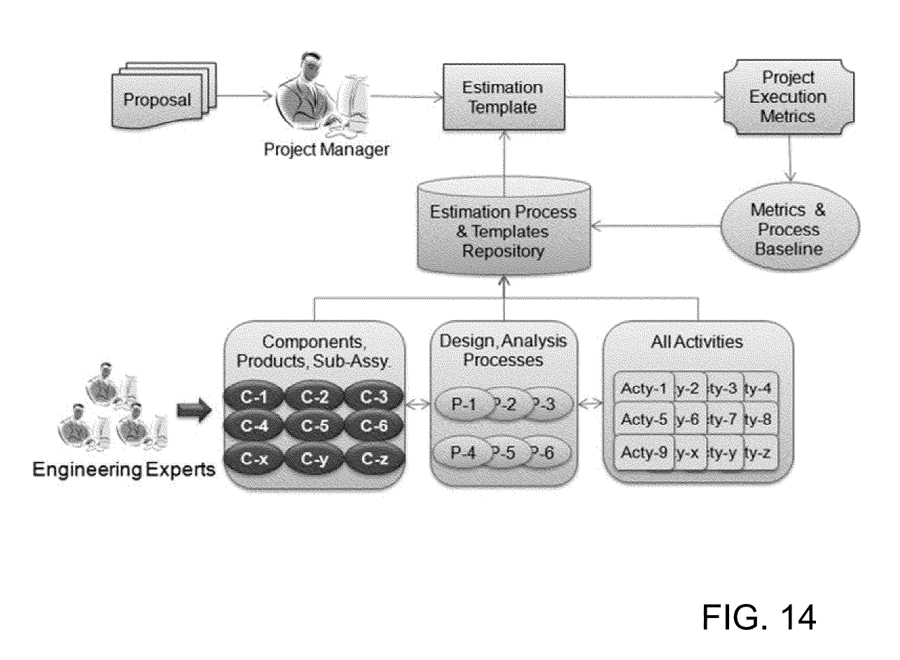

FIG. 14 is an illustrative explanation of knowledge based estimation service. Planning sessions were held to arrive at common understanding of the estimation approach between stakeholders and to gain agreement on the techniques to be used for developing the model. Key sponsors communicated and ensured that sufficient support in terms of resources, people, budget and time was funded for this effort. Assessments were made for piloting this in certain pockets of work and by establishing rapport with all the people in that department top-down as well as supporting groups that get involved in measuring and monitoring these services. Deploying the estimation framework, supported by appropriate tools for end users needs to address a few key functions: For the first few usage of the framework the historic effort for various activities needs to be put together by a team of experts from respective field of engineering services. Filtering of data should be done to ensure that only pertinent data points are considered and exceptions are excluded. These set of data will become the first baseline figures for initial reference and usage. FIG. 14 summarizes the complete process of how the effort estimates for a new engineering project is assessed based on certain pre-defined templates. Upon completion of the engineering project the real efforts for each of the engineering activities executed are captured in a structured repository. The whole execution process also facilitates continuous refinement of data residing in the reusable repository by engineering experts

Next, during every cycle of usage of the estimation framework for e.g. while bidding for new work or while renewing contracts (SoW) situation or in other similar situations, the variance between the estimated and actual efforts as observed for an engineering service will be analyzed and if required, refinements will be done to the baseline figures. The decision to make any such changes will be entirely based on expert opinion. Likewise, repeated use of different estimation needs for a variety of engineering services will not only increase the repository of past estimation related information but will also help in gradual reduction of variance between estimated and actual effort figures. New project execution parameters may be highlighted by users. A structured feedback mechanism needs to be in place and core team needs to take decision on when and where to adjust the model. All through the deployment, it is assumed that the framework itself will not need any major re-structuring. Key features and benefits of this model are: Completely parameterized, Self-contained definition of concepts and terms Standard templates, Pre-defined categories and complexities of work activities, Established methodology for adapting this to any industrial application of the engineering service.

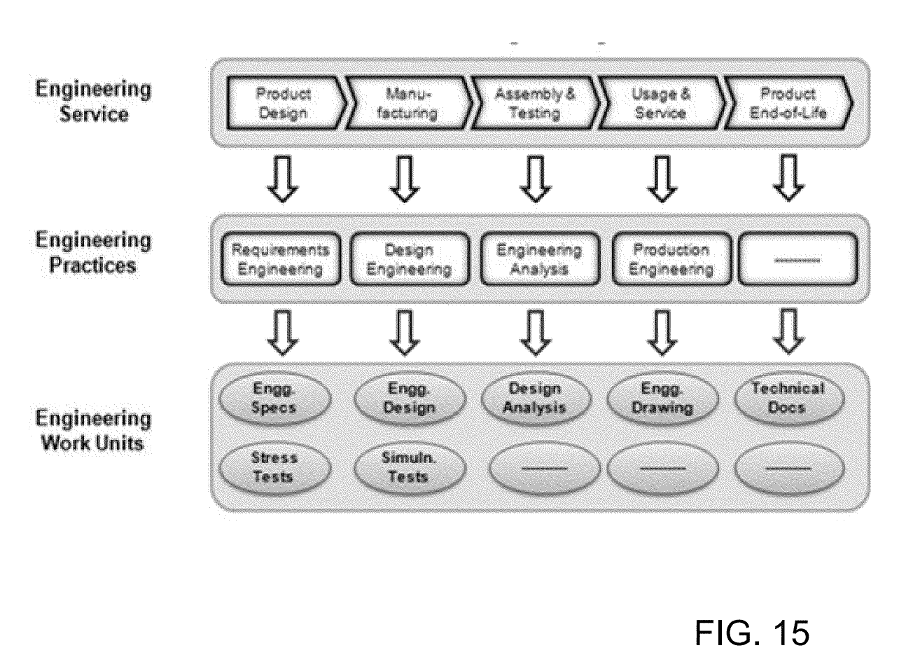

FIG. 15 is an illustrative explanation of structure of engineering work units show a possible way to componentize engineering services. The smallest level of engineering activity definition is mapped to an “Engineering work unit”. These engineering work units can be mapped upwards to engineering practices and they in turn are mapped to engineering services. Whereas the work done on conceptualizing and designing the estimation model, as described above is to establish a foundation for the framework, the next step is to consolidate and crystallize the framework into a well designed, scientific and clearly defined estimation system. We call this final system as “Engineering Unit of Work” (EUoW) estimation model. The intent is to define a measurement yardstick which could clearly identify a “Unit of Engineering Work”. The EUoW measurement yardstick will be independent of the type of engineering activity executed but at the same time it will be able to assist managers to compare and analyses different engineering functions that are executed across product and process engineering areas.

The measurement unit of an engineering function will be mapped to EUOWs. For example, in a particular engineering project execution situation, an engineering specification function could be equivalent to 5 EUoWs and an engineering design function could be 7 EUoWs. It is expected that users of the framework would then be able to not only compare the execution rate of various engineering services within their own organization (also known as “productivity”) but perhaps also compare the execution productivity of two totally different engineering services on an apple to apple basis of comparison. In the last phase it is intent to develop constraint driven estimation model which integrates dependencies (availability of required skills/resources, lead time to get skills/resources, policies etc).

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method comprising:
accepting a plurality of input details of a product;
choosing a component of the product for estimation;
choosing a complexity of the component;
selecting a stream for estimation;
selecting a process depending on the stream;
choosing the complexity of the process to estimate; and
estimating based on a pre-defined data.

2. The method of claim 1 further comprising:
enabling a user to alter a project execution factor.

3. The method of claim 1 further comprising:
generating a report after estimation based on the pre-defined data.

4. The method of claim 1 further comprising:
providing the user an option of experience based estimation.

5. The method of claim 1 further comprising enabling the user to perform at least one or more selected from the group consisting of:
increase a value in an effort parameter; and
decreasing the value in the effort parameter.

6. The method of claim 1 further comprising:
altering a number of activity headers.

7. The method of claim 1 further comprising:
removing an activity.

8. A system comprising:
an input module configured to accept a plurality of input details of a product;
a first selecting module configured to accept input from the input module and choose a component of the product for estimation, the first selecting module further configured to choose a complexity of the component;
a second selecting module configured to communicate with the first selecting module, the second selecting module is configured to select a stream for estimation, the second selecting module is further configured to select a process depending on the stream;
the second selecting module further configured to choose the complexity of the process to estimate; and
an estimating module configured to estimate based on a pre-defined data.

9. The system of claim 8 further comprising:
a processing module configured to enable a user to alter a project execution factor.

10. The system of claim 9 wherein the processing module is configured to generate a report after estimation based on the pre-defined data.

11. The system of claim 9 wherein the processing module is configured to provide the user an experience based estimation.

12. The system of claim 9 wherein the processing module is further configured to enable the user to perform at least one or more selected from the group consisting of:
increase a value in an effort parameter; and
decreasing the value in the effort parameter.

13. The system of claim 9 wherein the processing module is further configured to alter a number of activity headers.

14. The system of claim 9 wherein the processing module is further configured to remove an activity.

15. A computer program product, comprising a machine-accessible medium having instructions encoded thereon for enabling a processor to perform the operations of:
program code adapted for accepting a plurality of input details of a product;
program code adapted for choosing a component of the product for estimation;
program code adapted for choosing a complexity of the component;
program code adapted for selecting a stream for estimation;
program code adapted for selecting a process depending on the stream;
program code adapted for choosing the complexity of the process to estimate; and
program code adapted for estimating based on a pre-defined data.

16. The computer program product of claim 15, further comprising program code adapted for enabling a user to alter a project execution factor.

17. The computer program product of claim 15, further comprising program code adapted for generating a report after estimation based on the pre-defined data.

18. The computer program product of claim 15, further comprising program code adapted for providing the user an option of experience based estimation.

19. The computer program product of claim 15, further comprising program code adapted for enabling the user to perform at least one or more selected from the group consisting of:
increase a value in an effort parameter; and
decreasing the value in the effort parameter.

20. The computer program product of claim 15, further comprising program code adapted for altering a number of activity headers.

21. The computer program product of claim 15, further comprising program code adapted for removing an activity.

22. A method for dissecting a plurality of engineering activities in a product development lifecycle phases based on specific engineering processes applicable to the specific engineering stream, the method comprising:
organizing the plurality of engineering activities in a step by step execution process;
organizing the plurality of engineering activities based on repeatability of engineering activities for a specific engineering process; and
displaying an expected effort estimates.

23. The method of claim 22 further comprising the flexibility to work out the effort estimations based on a plurality of combinations of inputs, wherein the plurality of combinations of inputs comprising: a product component features, an engineering process complexity, and a project execution factors.

24. The method of claim 22 further comprising:
deriving the structure of engineering function units that can be adopted as the unit of measurement of engineering activities under the product engineering lifecycle phases.

25. The method of claim 22 further comprising mapping a smallest level of engineering activity definition is mapped to an Engineering Function Unit.

26. The method of claim 25 further comprising:
mapping the engineering function units can upwards to engineering practices and they in turn are mapped to product engineering services.
